(19) United States
(12) Patent Application Publication
(10) Pub. No.: US 2007/0080030 A1
(43) Pub. Date: Apr. 12, 2007

(54) Brake assembly for beds

(75) Inventor: Todd C. Kramer, Stevens Point, WI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Sunrise Medical HHG Inc.

(21) Appl. No.: 11/244,832

(22) Filed: Oct. 6, 2005

(51) Int. Cl. B60T 1/14

(52) U.S. Cl. 188/5

(57) ABSTRACT

A brake assembly particularly suitable for use with an articulating bed comprises a contact member that is adapted to be situated between the bed and a supporting surface. A resilient member is situated to act upon the contact member to cause the contact member to engage the supporting surface to resist movement of the bed relative to the supporting surface without significantly raising the bed up off the supporting surface.

### BACKGROUND OF INVENTION

This invention relates generally to beds and, more particularly, to convalescent beds. Most particularly, the invention relates to a brake assembly for articulated beds.

Articulating beds are typically supported for movement relative to a supporting surface by casters, which are usually coupled to legs at opposing ends of the bed. Conventional brake assemblies generally include pads that, upon activating the brake assembly, are displaced to frictionally engage the supporting surface to raise the casters up out of engagement with the supporting surface. Raising the casters in turn raises the legs to which the casters are attached, which raises a corresponding portion of the bed supported by the legs. Upon deactivating the brake assembly, the casters are lowered back into engagement with the supporting surface to permit movement of the bed. The corresponding portion of the bed is abruptly lowered due of the weight of the bed and the occupant. This frequently startles or otherwise causes discomfort or inconvenience to the bed occupant.

What is needed is a brake assembly that does not startle or cause discomfort or inconvenience to the occupant of an articulating bed.

### SUMMARY OF INVENTION

The present invention is directed towards a brake assembly that does not startle or cause discomfort or inconvenience to the occupant of an articulating bed. The brake assembly comprises a contact member that is adapted to be situated between the bed and a supporting surface. A resilient member is situated to act upon the contact member to cause the contact member to engage the supporting surface to resist movement of the bed relative to the supporting surface without significantly raising the bed up off the supporting surface.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a side elevational view of a brake assembly according to the invention situated between a bed and a supporting surface.

FIG. 2 is a partially exploded perspective view of the brake assembly shown in FIG. 1, mounted to a caster mounting bracket, with a lever for operating the brake assembly removed to simplify the drawing.

FIG. 3 is a cross-sectional view, in elevational, of the brake assembly shown in FIG. 1.

FIG. 4 is a side elevational view of the brake assembly activated to cause a contact member to engage a supporting surface to resist movement of the bed relative to the supporting surface.

### DETAILED DESCRIPTION

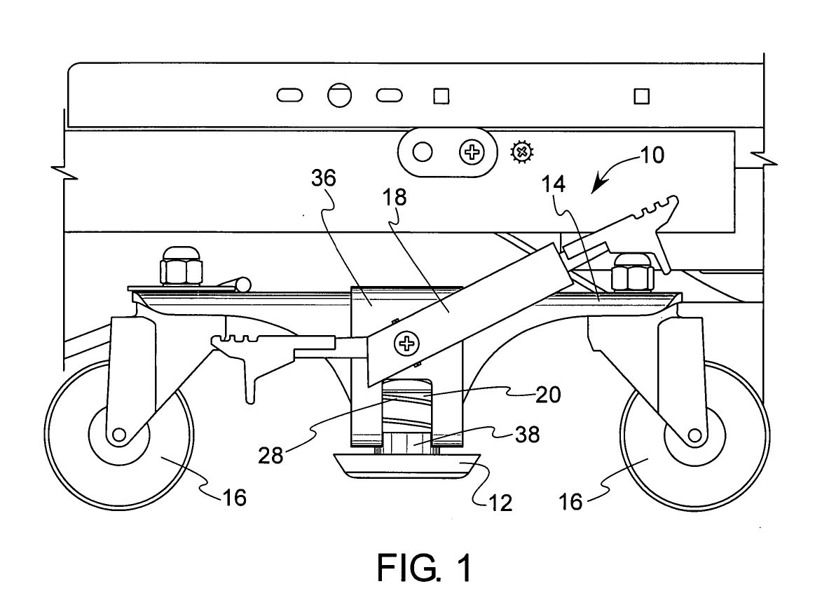

Now with reference to the drawings, there is illustrated in FIG. 1 a brake assembly, generally indicated at 10, in accordance with the invention. The brake assembly 10 is adapted to be attached to an articulated bed via a leg or other suitable structure of the bed. The brake assembly 10 includes a contact member or a pad 12 that is adapted to be moved or displaced to frictionally engage the supporting surface, or otherwise engage the supporting surface to prevent the bed from moving relative to the supporting surface, upon activating the brake assembly 10. In general, the pad 12 is adapted to be situated between the bed and the supporting surface. This may be accomplished in any suitable manner.

As illustrated in the drawing, the brake assembly 10 may be supported relative a caster mounting bracket 14, which may be attached to the leg of an articulated bed. The bracket 14 may be adapted to support one or more casters 16, which may be adapted to support the bed for movement relative to the supporting surface. The bracket 14 illustrated is an elongated bracket having opposing ends. At least one caster 16 may be attached to each of the opposing ends.

The brake assembly 10 is operable or otherwise adapted to be activated and deactivated in any suitable manner. The brake assembly 10 illustrated is operable or activated and deactivated via a lever 18, although other suitable means including but not limited to a motor may activate and deactivate the brake assembly 10. The lever 18 shown is an elongate lever having opposing ends that are adapted to be engaged by the foot of an operator to apply a force against the lever. Application of force against one end of the lever 18 to move the lever 18 in a first direction may activate the brake assembly 10 and application of force against the other end of the lever 18 to move the lever 18 in a second direction may deactivate the brake assembly 10.

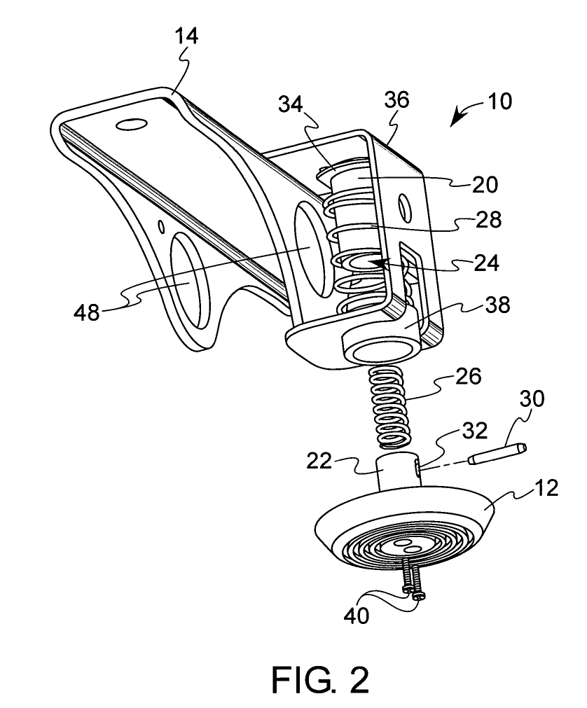

Now with reference to FIG. 2, there is illustrated a partially exploded view of the brake assembly 10, mounted to the caster mounting bracket 14, with the lever 18 removed to simplify further description of the invention. The brake assembly 10 may be comprised of one or more members or actuating elements, such as the first and second members or pins 20, 22 shown. In the illustrated embodiment, the first and second pins 20, 22 are substantially rigid and substantially concentrically disposed. The first pin 20 in the illustrated embodiment of the invention is a hollow pin having a hollow interior and opposing ends. A lower end is provided with an opening 24 leading to the hollow interior of the pin 20. An upper end of the first pin 20 is preferably closed or otherwise provided with a stop to restrict or prevent passage through the pin 20. In the illustrated embodiment of the invention, the stop may prevent passage of a resilient member through the first pin 20. This resilient member may be a compliant member, an elastic member, or a compressible member, such as one of two springs, which in the illustrated embodiment, are first and second springs 26, 28. Although helical springs are shown, it should be noted that any element suitable for applying force in accordance with the invention may be employed. In general terms, the resilient member is situated to act on the contact member or pad 12. More particularly, the resilient member is situated between the first and second members or pins 20, 22 and one of the members or pins 22 is situated between the resilient member and the contact member or pad 12. In this way, one of the members or pins 20 may act on one of the resilient member, which may act on the other member or pin 22, which may be supported for movement relative to the contact member or pad 12, and which may act on the contact member or pad 12.

Now, in the illustrated embodiment, the spring within the first pin 20, which for purposes of this description is the first spring 26, is adapted to be held within the hollow interior of the first pin 20 by the second pin 22, which in supported for movement relative to the first pin 20, and which preferably engages the opening 24 leading to the hollow interior of the pin 20. In the illustrated embodiment, the second pin 22 is held at least partially within the first pin 20 by a roll pin 30, or other suitable retainer. With regard to the illustrated embodiment, the first pin 20 has a hole (not shown) therein and the second pin 22 has a slot 32 in which the roll pin 30 is permitted to move or travel. It is the engagement of the roll pin 30 with the hole and slot 32, or the passage of the roll pin 30 through hole and slot 32, that supports the second pin 22 for movement relative to the first pin 20. The dimension of the slot 32 may limit the movement of the second pin 22 relative to the first pin 20 to a determined or otherwise desired movement.

The second spring 28 may be adapted to engage the first pin 20 and is preferably disposed about the first pin 20. This spring 28 engages a flange 34, or other suitable structure, at the upper end of the first pin 20. In this way, movement of the first pin 20 in a first or downward direction, upon activating the brake 10, will compress the spring 28, which, as will become more apparent in the description that follows, will function as a return spring to urge the first pin 20 to move in a second or upward direction upon deactivating the brake assembly 10.

The pins 20, 22 and springs 26, 28 collectively may form an actuator that may be supported for movement within a housing 36, or other suitable structure, which in turn may be coupled, attached or otherwise supported relative to the bed or caster mounting bracket 14. A passage through a lower end of the housing 36 may permit the second pin 22 to extend from the housing 36. The passage 36, or as in the case of the illustrated embodiment, a bushing 38 supported relative thereto, may be dimensioned or otherwise configured to restrict or limit movement or travel of the first pin 20, and thus restrict or limit movement or travel of the second pin 22 in a first or downward direction relative to the housing 36. Likewise, the bushing 38 may be dimensioned or otherwise configured to restrict or limit movement or travel of the second spring 28. In this way, the second spring 28 is captured between the flange 34 and the bushing 38. The bushing 38 is preferred to permit smooth travel of the second pin 22 through the passage 36 while minimizing wear on the second pin 22.

The contact member or pad 12 may be attached to a lower end of the second pin 22. The pad 12 may be any suitable element that can engage the supporting surface in such a manner as to restrict movement of the bed or prevent the bed from moving relative to the supporting surface. For example, the pad 12 may be comprised of a washer (not shown) or other suitable element having a material, such as rubber or other suitable material, about it. The material may be formed about the washer and is preferably of the character that it frictionally engages the supporting surface upon application of a force. The pad 12 may be attached to the second pin 22 in any suitable manner. In the illustrated embodiment, the pad 12 is attached to the pin 22 via fasteners 40, such as threaded fasteners, that pass through holes (not shown) in the pad, and, for example, the washer therein, and engage the second pin 22 or, in the case of threaded fasteners, are threaded into corresponding threaded holes (also not shown) in the lower end of the second pin 22. It should be fully appreciated that the pad 12 may be attached in a manner other than that shown.

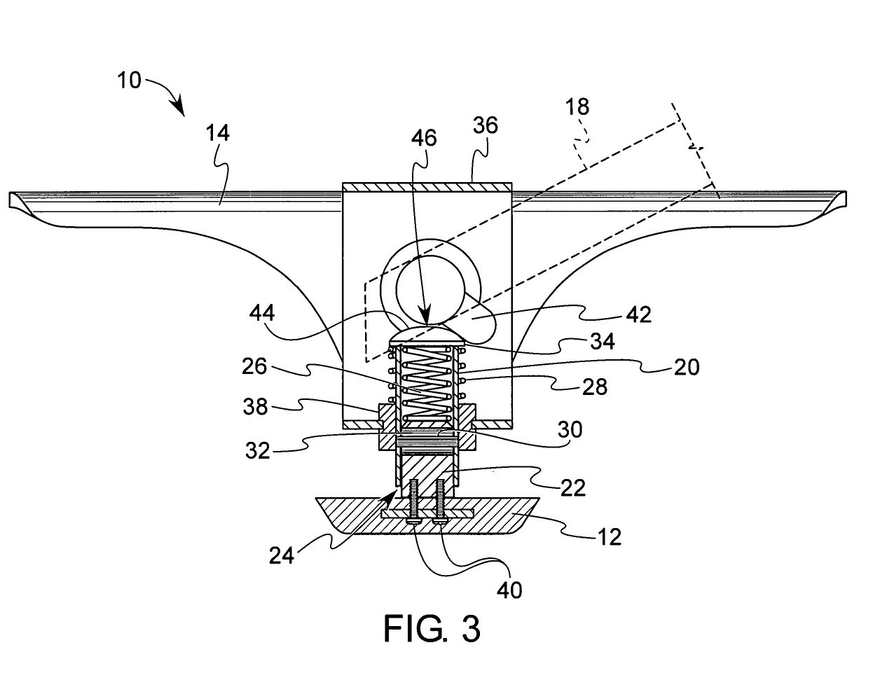

Now, with reference to FIG. 3, there is illustrated a cam configuration suitable for activating the brake configuration. Although other configurations may be suitable for carrying out the invention, the illustrated cam configuration has a cam 42 that is supported in a fixed relation to the lever 18. The cam 42 is adapted to engage a cam surface 44 at the upper end of the first pin 20. In the illustrated embodiment, the cam surface 42 is defined by the upper end of a mushroom shaped head, generally indicated at 46, at the upper end of the first pin 20, and which may be formed integrally with the first pin 20. In this manner, the head 46 functions as a stop to prevent passage of the first spring 26 and second pin 22 through the first pin 20, as mentioned in the description above.

Upon rotating the lever 18, for example, in a clockwise direction when viewing FIG. 3, the cam 42 pushed against the cam surface 44 to urge the first pin 20 in a first or downward direction. This downward movement compresses the second spring 28 between the flange 34 and the housing 36 or bushing 38. The second pin 22 is likewise moved downwardly, moving the pad 12 downward. The pad 12 is adapted to engage the supporting surface. Further downward movement of the first pin 20 following this engagement is permitted by the travel of the roll pin 30 in the slot 32. Relative movement between the first and second pins 20, 28 at this juncture compresses the first spring 26. Downward force applied against the second pin 22 is transmitted through the second pin 28 to the pad 12, which in turn should frictionally engage the supporting surface to resist movement of the articulating bed relative to the supporting surface. Rotating the lever 18 in a counter-clockwise direction, when viewing FIG. 3, permits the second spring 28 to urge the first pin 20 in a second or upward direction, causing the pad 12 to disengage the supporting surface and thus permit the articulating bed to be moved relative to the supporting surface. It should be appreciated that the first spring 26 may urge the second pin 22 downward relative to the first pin 20 as the roll pin 30 moves downward in the slot 32.

The caster mounting bracket 14 shown may be attached to the leg of the articulating bed in any suitable manner. The bracket 14 shown has a hole 48 passing therethrough through which may pass a cross member (not shown) at the lower end of the leg of the articulating bed. The cross member may be pivotally supported by the caster mounting bracket 14 to enable the leg to pivot relative to the bracket 14 as the leg is articulated to raised or lower the bed. It should be noted that the illustrated bracket is provided for illustrative purposes and that other bracket configurations may be provided for supporting the brake assembly 10 relative to the articulating bed. It should further be noted that the brake assembly 10 may be supported relative to the articulating bed, or other beds, including non-articulating beds, in other suitable manners, such as without the aid of the caster mounting bracket 14.

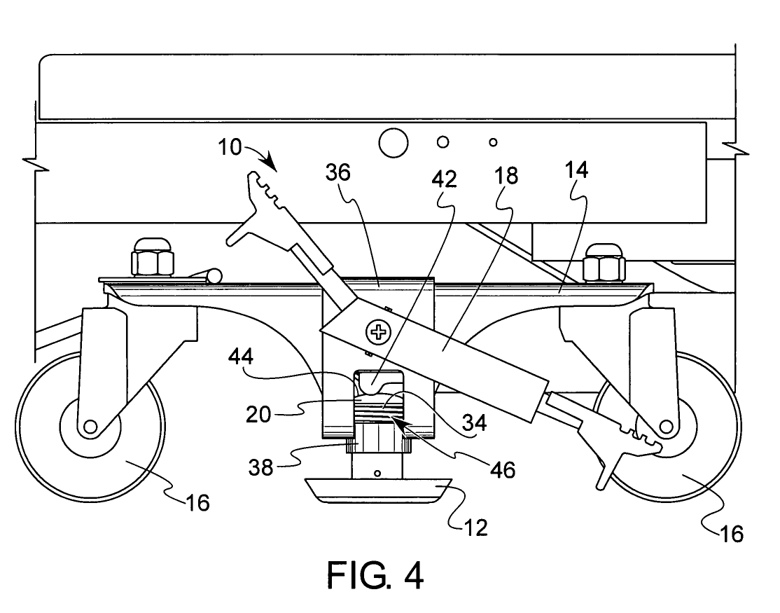

It should be fully apparent now that, when the brake assembly 10 is deactivated, the pad 12 is raised so as to not frictionally engage the supporting surface, as shown in FIG. 1. In this condition, the pad 12 does not interfere with movement of the articulating bed relative to the supporting surface. Upon activating the brake assembly 10, the pad 12 frictionally engages the supporting surface to resist movement of the articulating bed relative to the supporting surface, as shown in FIG. 4. In the preferred embodiment of the invention, neither the casters nor the leg are raised up out of engagement with the supporting surface. Consequently, a corresponding portion of the bed supported by the legs is not raised. As a result, the corresponding portion of the bed is not abruptly lowered upon deactivating the brake assembly 10. In addition, activating the brakes assembly 10 requires the same force applied to the lever 18, regardless of the weight of the bed and the occupant thereon because the brake assembly 10, according to the preferred embodiment, does not raise the bed.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A brake assembly for a bed comprising:
a contact member adapted to be situated between the bed and a supporting surface; and
a resilient member situated to act upon the contact member to cause the contact member to engage the supporting surface to resist movement of the bed relative to the supporting surface without significantly raising the bed up off the supporting surface.

2. The brake assembly of claim 1, further comprising a first member, the brake assembly being operable to cause the first member to act upon the resilient member, which in turn acts upon the contact member to cause the contact member to engage the supporting surface.

3. The brake assembly of claim 2, further comprising a second member supported for movement relative to the first member, the resilient member being situated between the first and second members.

4. The brake assembly of claim 1, further comprising substantially rigid first and second members, wherein the resilient member is situated between the first and second members and one of the first and second members is situated between the resilient member and the contact member.

5. The brake assembly of claim 1, further comprising first and second pins, the first pin having a hollow interior and opposing ends with an opening at one of the ends leading to the hollow interior and a stop at the other one of the ends to restrict passage through the first pin, and wherein the resilient member comprises a first spring in the first pin between the second pin and the stop.

6. The brake assembly of claim 5, wherein the first and second pins are concentrically disposed.

7. The brake assembly of claim 1, further comprising first and second pins, the first pin having a hollow interior, a stop at an upper end thereof, and an opening at a lower end thereof, the second pin engaging the opening, the resilient member being a first spring held within the hollow interior between the stop and the second pin.

8. The brake assembly of claim 7, wherein the first pin has a flange at the upper end thereof and a second spring adapted to engage the flange, the second spring being compressed by the flange during movement of the first pin in a first direction and functioning as a return spring to urge the first pin to move in a second direction.

9. The brake assembly of claim 8, wherein the springs are helical springs.

10. The brake assembly of claim 9, wherein the first and second pins are supported for movement within a housing that is adapted to be coupled to the bed, the housing having a passage through a lower end thereof, the second pin engaging the passage.

11. The brake assembly of claim 10, further comprising a bushing supported relative to the housing, the bushing limiting movement of the first pin while permitting the second pin to move therein.

12. The brake assembly of claim 7, wherein the second pin is held at least partially within the first pin by a retainer.

13. The brake assembly of claim 12, wherein the first pin has a hole that passes therethrough and the second pin has a slot therein, and wherein the retainer is a retainer pin that engages the hole and the slot and is permitted to move in the slot, whereby the retainer pin supports the second pin for limited movement relative to the first pin.

14. The brake assembly of claim 7, wherein the contact member is a pad comprised of a washer and rubber formed about the washer, the pad being attached to the second pin via a fastener that pass through a hole in the rubber and the washer and that engages the lower end of the second pin.

15. The brake assembly of claim 7, further comprising a lever, the brake assembly being operable by the lever.

16. The brake assembly of claim 15, further comprising a cam that is supported in a fixed relation to the lever, the cam being adapted to engage a cam surface at the upper end of the first pin, whereby upon moving the lever in a first direction, the cam engages the cam surface to urge the first pin in a first direction to compress the first spring, whereby force from the compressed spring is transmitted through the second pin to the contact member to cause the contact member to engage the supporting surface.

17. The brake assembly of claim 16, wherein the cam surface is defined by a mushroom shaped head at the upper end of the first pin.

18. The brake assembly of claim 17, further comprising a second spring positioned relative to the first pin, whereby movement of the first pin in the first direction causes the second spring to be compressed by the mushroom shaped head and movement of the lever in a second direction permits the second spring to exert force on the mushroom shaped head to urge the first pin in a second direction, opposite the first direction.

19. The brake assembly of claim 15, wherein the lever is elongated and has opposing ends that are adapted to be engaged by the foot of an operator to apply a force against the lever, whereby application of force against one end of the lever activates the brake assembly and application of force against the other end of the lever deactivates the brake assembly.

20. The brake assembly of claim 1, further comprising a caster mounting bracket that is adapted to be attached relative to the leg of the bed for supporting the brake assembly relative to the bed, the bracket further being adapted to support one or more casters, which are adapted to support the bed for movement relative to the supporting surface.

21. The brake assembly of claim 1, further comprising an elongated caster mounting bracket having opposing ends with a caster attached to each of the opposing ends.

22. The brake assembly of claim 1, wherein the brake assembly is configured to cause the resilient member to apply a constant force to the contact member independent of the weight of the bed and its occupant.

23. A brake assembly for use on a bed that is adapted to be supported for movement relative to a supporting surface, the assembly comprising:
a lever that is adapted to be displaced between an activated position and a deactivated position;
a pad that is adapted to engage the supporting surface to resist movement of the bed relative to the supporting surface upon activating the lever; and
a resilient element between the lever and the pad, the compressible element applying force against the pad upon activating the lever the force the pad into engagement with the supporting surface to resist movement of the bed relative to the supporting surface without significantly raising the bed up off the supporting surface.
